(19) United States
(12) Patent Application Publication
(10) Pub. No.: US 2003/0171926 A1
(43) Pub. Date: Sep. 11, 2003

(54) System for information storage, retrieval and voice based content search and methods thereof

(76) Inventors: Narasimha Suresh, Bangalore (IN); Sudarshan Bhide, Pune (IN)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/108,875

(22) Filed: Mar. 27, 2002

(30) Foreign Application Priority Data
Mar. 7, 2002 (IN) 220/MUM/2002

(51) Int. Cl. G10L 21/00

(52) U.S. Cl. 704/270.1

(57) ABSTRACT

An information retrieval system for voice-based applications enabling voice based content search is provided. The system comprises a remote communication device for communication through a telecommunication network, a data storage server for storing data and an adaptive indexer interfacing with a speech recognition platform. Further the adaptive indexer is coupled to a content extractor. The adaptive indexer indexes the contents in configured manner and the local memory stores the link to the indexed contents. The speech recognition platform recognizes the voice input with the help of a dynamic grammar generator and the results thereof is encapsulated into a markup language document. Employing the speech recognition results a search is performed by a search engine using the indexed contents and the results is returned to the originator of the search input. Systems are provided to perform the methods.

### TECHNICAL FIELD

This invention in general relates to communication systems including information storage and retrieval mechanisms. More particularly, the invention relates to voice recognition systems and methods and to information storage and retrieval systems and methods.

### BACKGROUND OF THE INVENTION

The frequency of accessing searchable databases stored in electronic medium by users of hand-held communication devices like mobile telephones has considerably increased in the recent past. However there are a number of factors that limit the utility parameters of a system that enables such hand held device holders to access databases for retrieval of information. This is specifically so, when the end user employs devices like mobile telephones, internet capable mobile phones, Personal Digital Assistants with wireless capability for accessing a generic database catering to a variety of requirements. The limitations of these devices in respect of system capabilities pose a major impediment in quick and easy access to the target data that the end user is looking for. These limiting factors of a hand-held device further include limited rendering capabilities as compared to Personal Computers, parameters like form factor, absence of a Graphical User Interface for telephone and limited processing powers.

Conventional art employing telephonic devices for data access employs voice as the only medium for presenting information. A conventional system in which user provides input and receives output through a telephone is an Interactive Voice Response (IVR) system, wherein the user is presented with a menu in the form of a voice file. User responds to the menu by pressing a digit on the telephony instrument. This response is then processed by the system and the result is dispatched to the user again in the form of a voice file. This system is suitable for applications having limited options to choose from (e.g. telephone based banking service).

However, for applications that require more detailed inputs from the user, this system becomes cumbersome to use. This necessitates the use of voice recognition to accept input from the user. User can speak out what he wants from the system and the system will respond accordingly. But the use of voice recognition alone does not resolve all technical problems associated with a data storage and retrieval system for telephony applications. As for example, yet another complexity stems from the generic nature of the data stored and the multiplicity of end users looking for speedy retrieval of targeted information. Thus there are issues associated with the system when a variety of content is generated and accessed. Also factors like performance, resource utilization (processing power and memory requirement), voice-recognition, etc. further shrink the possibilities of application providers providing for such a system.

Existing solutions for voice-based search cater to specific search needs. They are built for specific applications and as such are well designed for those applications. However, this limits the spectrum of content that can be searched using voice since they are built for specific applications.

Current speech applications include Voice XML, the Voice Extensible Markup Language. Voice XML is designed for creating audio dialogs that feature synthesized speech, digitized audio, recognition of spoken and Dual-Tone Multi Frequency (DTMF), also known as Touch Tone. DTMF is commonly used in remote control applications that use telephones. Examples for these applications are accessing your messages from an answering machine and retrieving your account balance information from your bank database. Also Voice XML has applications for recording of spoken key input, telephony, and mixed-initiative conversations. The Voice XML standard is described in detail in www.voicexmlreview.org. The World Wide Web Consortium [W3C] has brought out specifications of a revised speech recognition grammar format aimed at enhancing the interoperability of Voice XML browsers and Voice XML applications. This W3C speech recognition format is described in detail in www.w3.org. The Voice XML 1.0 version employs Java Speech Grammar Format [JSGF]. Current versions of Voice XML employ mostly native grammar formats of the speech recognizer embodied in the browser. The Voice XML version 2.0 provides grammar interoperability [www.w3.org/TR/speech-grammar].

Speech Application Language Tags [SALT] is another speech interface markup language, which comprises of a small set of XML elements. SALT can be used with Hyper Text Mark-up Language [HTML] and other standards to write speech interfaces for voice-only or multimodal applications. The SALT standard is described in detail in www.saltforum.org.

Advances in voice-recognition technologies has made it easier for end-users to have access to increasing amount of data through voice since the number of applications that are being voice-enabled is increasing. However, this means that users have to go through larger and larger volumes of data to reach the information they want. Given the limited rendering capabilities of the telephone, it is required that users be able to search for the specific information they want.

### SUMMARY OF THE INVENTION

The invention provides for a system for information storage, retrieval and voice based content search. The system comprises of a remote communications device configured to communicate through a telecommunication network; a base station in communication with the mobile device, the base station having a data storage server for storing data, an information retrieval system having an adaptive indexer and a speech recognition platform interfacing with the adaptive indexer; the base station being remote from the communication device selectively communicates with the communication device, wherein the system is configured to perform voice based content search using the speech recognition platform and the information retrieval system.

Another aspect of the invention provides a system for information retrieval and voice based content search, the system comprising a remote communications device configured to communicate through a telecommunication network, a base station in communication with the mobile device, the base station having an information retrieval system comprising a server storage for storing contents, a content extractor for extracting contents from the server storage, an adaptive indexer for adaptively indexing contents extracted by the content extractor, a core indexer for collecting textual information from the extracted contents, an index configurator for configuring the adaptive indexer using the extracted contents, a content cataloguer for cataloguing the indexed contents, an index re-shuffler for periodical reshuffling of the indexed contents, a local memory for storing contents, the memory positioned proximally to the storage adapter, a storage adapter configured to provide access to the contents stored in the local memory, a dynamic grammar generator configured to generate speech recognition grammar, a voice information retrieval interface operatively interfacing with the dynamic grammar generator, a speech recognition platform interfacing with the voice information retrieval interface, a markup language generator/parser configured to create and interpret contents using voice mark up languages, and wherein the base station further comprising a search engine coupled to the voice information retrieval interface, the adaptive indexer operatively connected to the content extractor, the content extractor configured to perform indexing of contents extracted from the remote server storage, the core indexer extracts textual matter from the contents, the contents being catalogued by a content cataloguer, indexed contents being stored in the local memory, the storage adapter configured to provide access to the contents stored in the local memory, the dynamic grammar generator configured to generate speech recognition grammar, the markup language generator configured to wrap the grammar into a markup language document, the voice information retrieval interface configured to send the markup language document to the speech recognition platform, the speech recognition platform configured to use the document received from the information retrieval interface to recognizing the user input, the speech recognition platform returns the results thereof to the search engine, the search engine configured to perform search using the speech recognition results and the indexed contents and returns the results thereof as a markup language document to the speech recognition platform.

In yet another aspect the invention provides an adaptive indexing system for adaptively indexing contents for use in an information retrieval system, the system comprising an adaptive indexer configured to index contents, a core indexer configured to implement textual extraction from contents forwarded by the adaptive indexer, an index re-shuffler configured to at times reshuffle contents, an index configurator for indexing the contents received by the adaptive indexer employing a plurality of configuration parameters, an index cataloguer interfacing with the adaptive indexer configured to perform cataloguing of the contents and maintaining a per-user catalogue configured for a specific content type wherein the index cataloguer is configured to selectively load the indices upon receipt of a search request, a duplicate word remover for removing duplicate words from the indexed contents, a local memory for storing contents, the memory positioned proximally to the storage adapter, a storage adapter configured to provide access to the contents stored in the local memory, an exclusion dictionary configured to exclude irrelevant words from the indexed contents, a dynamic grammar generator configured to generate speech recognition grammar and wherein the adaptive indexer coupled to the index configurator, the core indexer and the storage adaptor indexes the contents to define a user index and a common index, the grammar generator configured to process search requests to conduct searches using the user indexes and the common indexes and performs context sensitive selective loading of indices.

In still another aspect the invention provides for a method for voice based content search and information retrieval; the method comprising sending a voice based search request by a device capable of communicating through a telecommunication network, receiving the voice based search input by a speech recognition platform, establishing a search session by the speech recognition platform conjointly with a voice information retrieval interface, generating a dynamic grammar in respect of the search input by a dynamic grammar generator, encapsulating the dynamic grammar into a voice markup language document by a markup language generator, sending the voice markup language document containing the dynamic grammar generator to the speech recognition platform, performing a speech recognition test by the speech recognition platform and returning the test results thereof to the voice information retrieval interface, conducting a search using the test results by a search engine at the local memory and employing the indexed content, providing the search results as a voice markup language documents to the speech recognition platform and returning the search results to the originator of the search input.

### BRIEF DESCRIPTION OF THE DRAWINGS

Preferred embodiments of the invention are described below with reference to the following accompanying drawings.

FIG. 1 is a block diagram illustrating a system embodying the invention.

FIG. 2 is a block diagram illustrating more details of some of the components included in the system of FIG. 1.

FIG. 3 is a diagram illustrating the base station as embodying in the system of FIG. 1.

FIG. 4 is a diagram illustrating the adaptive indexer configured with content sources.

FIG. 5 is a block diagram illustrating emails, scanned documents and word processor documents as source contents.

FIG. 6 is a diagram illustrating sources emails as the content source as embodying in the system of FIG. 4.

FIG. 7 is a diagram illustrating scanned page as the data source as embodying in the system of FIG. 4.

FIG. 8 is a diagram illustrating word processor document as the data source as embodying in the system of FIG. 4.

FIG. 9 illustrates a conventional inverted indexing mechanism adapted to email indexing.

FIG. 10 illustrates a sample index generated for the sources: email, scanned pages, word processor documents.

FIGS. 11-A, 11-B and 11-C are flowcharts illustrating the method of operation of the systems shown in FIG. 1 and FIG. 2.

FIG. 12 illustrates the indexing process for generic content sources.

FIG. 13 illustrates the primary Indexing process for generic content sources.

FIG. 14 illustrates the primary indexing process for email content sources.

FIGS. 15-A and 15-B illustrate the primary indexing process for scanned pages content sources.

FIG. 16 illustrates the Indexing process for word processor documents content sources.

FIG. 17 illustrates secondary indexing process.

FIG. 18 illustrates search process for email content sources.

### DETAILED DESCRIPTION OF THE INVENTION

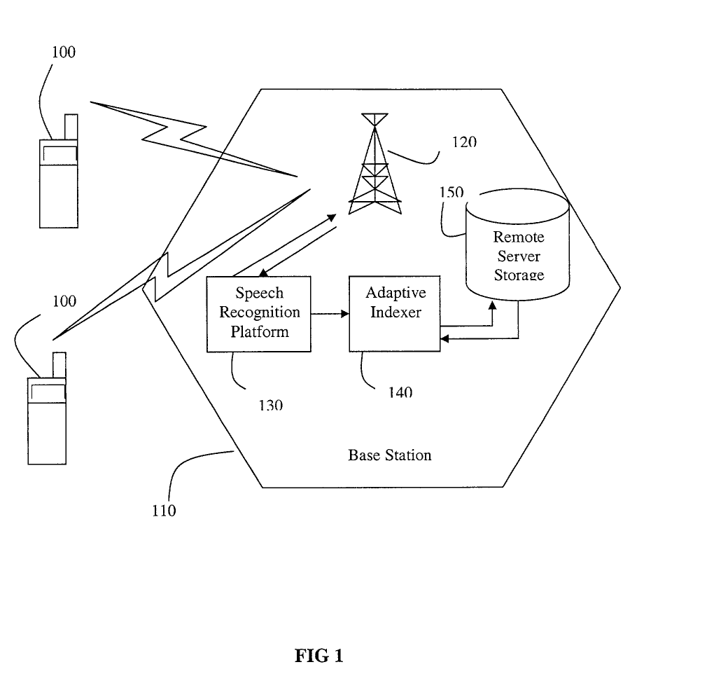

FIG. 1 illustrates the components and their major interactions in the system. The user 100 interfaces with the base station 110 through a communication network 120. The base station 110 comprises speech recognition platform 130, the adaptive indexer 140 and remote server storage 150.

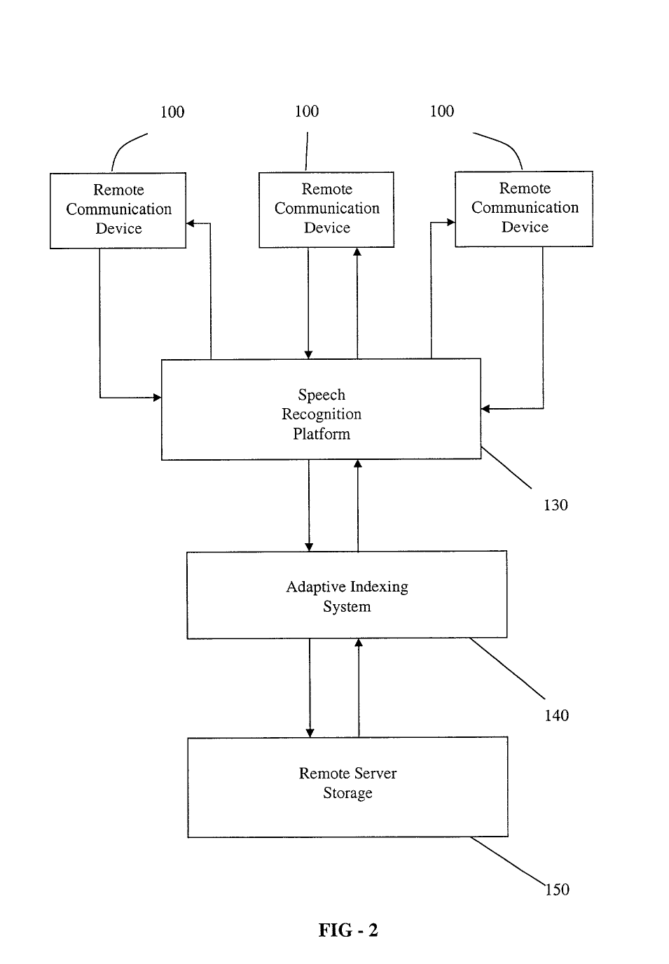

FIG. 2 illustrates a more detailed interaction of the components of FIG. 1. The speech recognition platform 130 is operatively connected with the adaptive indexer 140, which in turn is operatively coupled to the remote server storage 150.

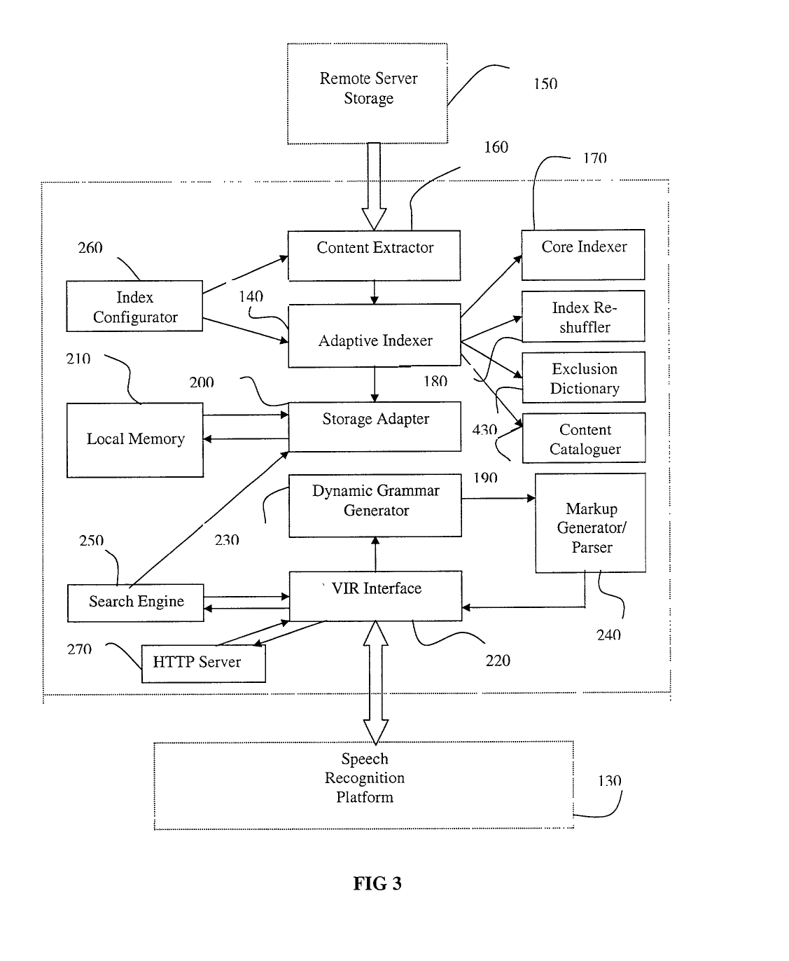

FIG. 3 shows the remote server storage 150. The server storage 150 comprises of storage locations for content (e.g. email server, document management system, etc). The content extractor 160 extracts content from the remote storage 150 in various formats. The adaptive indexer 140 then indexes all the incoming documents by forwarding the content to the respective core indexers 170 for the content type, to extract the relevant textual information from the document. The index data is then catalogued by the content cataloguer 190 and stored in the local memory 210 by the storage adapter 200, along with the access information for the documents. The local memory 210 can be, for example, a hard drive, optical disk, random access memory, read only memory, flash memory, or any other appropriate type of memory. The speech recognition platform 130 establishes a search session with the system through its Voice Information Retrieval Interface [VIR Interface] 220. Upon a search request, the dynamic grammar generator 230 loads the user index and generates a grammar for the search request. This grammar is then encapsulated in a voice based markup language document by the Markup generator/parser 240. The VIR Interface 220 sends this markup language voice based document to the external Speech Recognition platform 130, which performs recognition and returns the user input. Search engine 250 uses this input and the user index to perform search. Search hits are returned to the speech recognition platform 130 as a Markup language voice based document.

The index configurator 260 is employed to configure the indexer. The content extractor 160 is configured to extract textual data from content sources and data types. The index re-shuffler 180 is configured to optimize index storage. The Hyper-Text Transfer Protocol Server [HTTP Server] 270 is used by the VIR Interface 220 to accept requests from the speech recognition platform 130. Remote Server Storage 150 is the location where the message/content is physically stored. The present invention does not store the actual content in the local memory. However, it maintains links to the exact location of a document on the remote storage. Examples of remote storage include mail server, document management System or a hard disk. The index configurator 260 is used for configuration of contents. Since content can be from any source, the exact details of the source need to be specified. Various configuration parameters include content type, content source and access details. For instance, in case of email content, we need to provide details corresponding to standard email access protocols like IMAP (Internet Message Access Protocol) and POP3 (Post Office Protocol Version 3). Detailed description and specification can be found at the Internet address: http://www.imap.org. Detailed description and specification of POP3 protocol can be found at the Internet address: http://www.cis.ohio-state.edu/cgi-bin/rfc/rfc1939.html. Details to be given include server details, user-id and password. The content extractor 160 uses a polling mechanism for importing content.

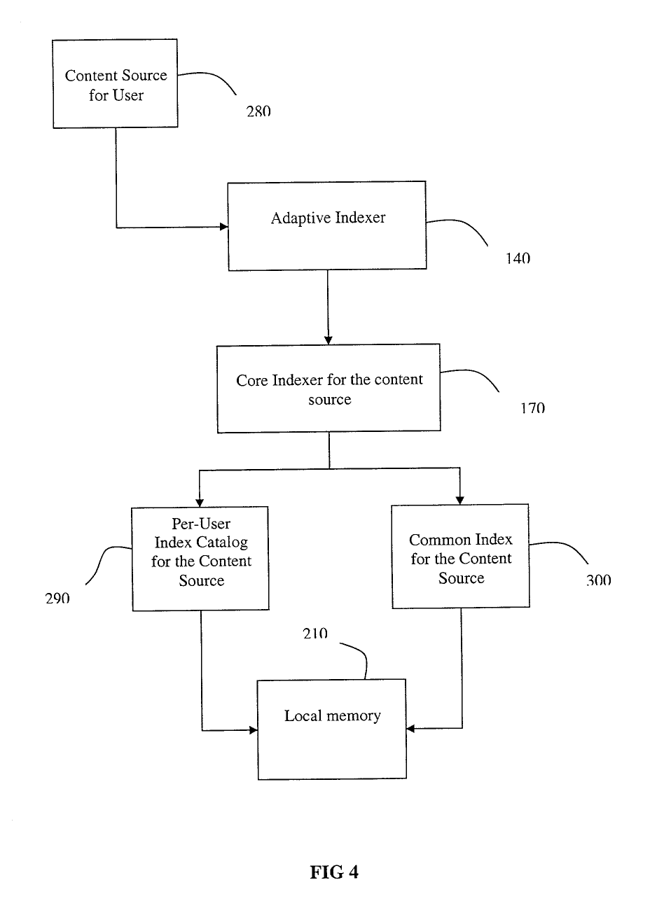

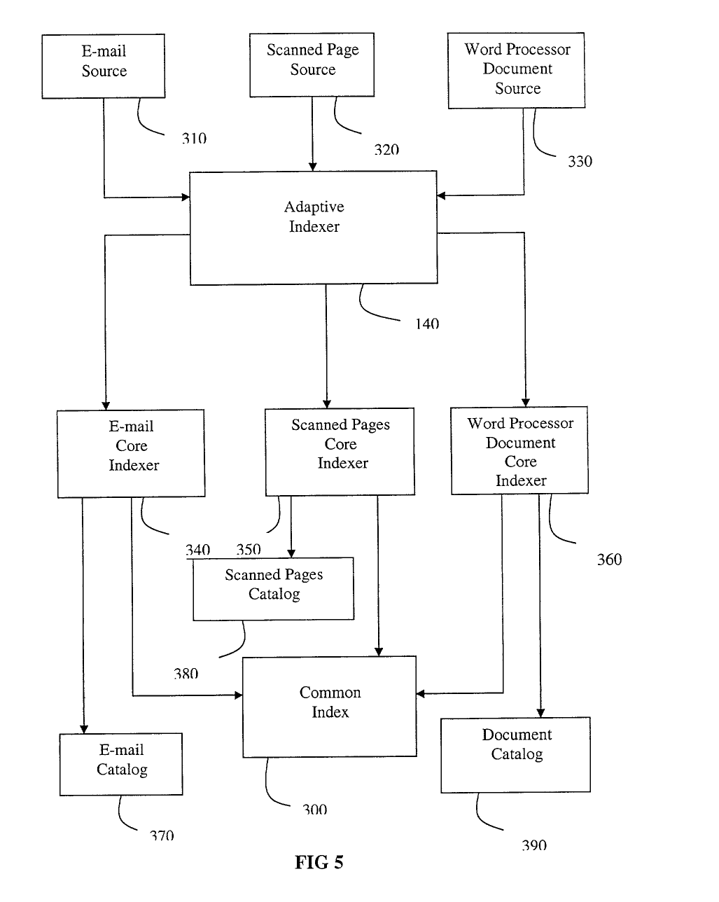

FIG. 4 illustrates the employment of adaptive indexer 140 for a content source. The adaptive indexer 140 is employed to index content. The adaptive indexer 140 is responsible for indexing all the incoming documents coming in from Content Source for User 280, cataloguing the indices and storing these indices in the local memory, which can be, for example, a hard drive, floppy disk, optical disk, random access memory, read only memory, flash memory, or any other appropriate type of memory. For a voice-based content search system, the amount of searchable data should be kept at a minimum given the resource requirements for speech recognition. The present invention solves this problem through cataloguing of indices. The adaptive indexer 140 can be configured with the required types of content. Core indexing for each configured content type is implemented in a separate core indexer 170, which is referenced by the adaptive indexer 140. As a result, the adaptive indexer 140 consists of core indexers 170 and request delegating mechanisms for core indexing. Cataloguing updates index in the per-user catalog for the content source 280 and the common index 300. These catalogs are stored in the local memory 210.

In FIG. 5, the adaptive indexer 140 is configured for email source 310, scanned pages source 320 and word processor documents source 330, as the content sources. Adaptive Indexer 140 delegates indexing operations to respective core indexers 170 i.e. email core indexer 340, scanned pages core indexer 350 and word processor document core indexer 360. Each of these core indexers generate index for the respective content and the index is updated in respective catalogs i.e. email catalog 370, scanned pages catalog 380 and word processor documents catalog 390. Common index elements are updated in the common index 300.

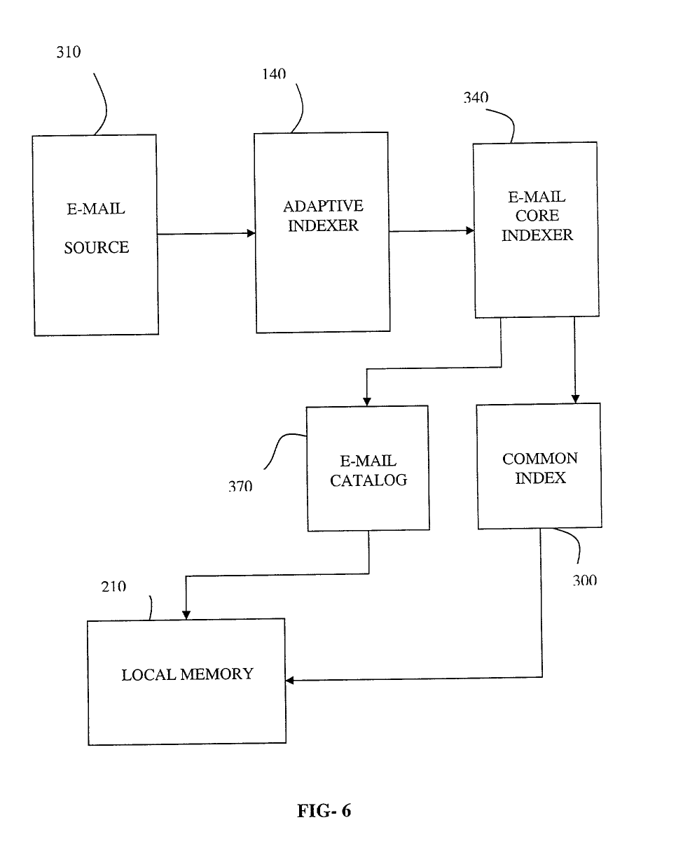

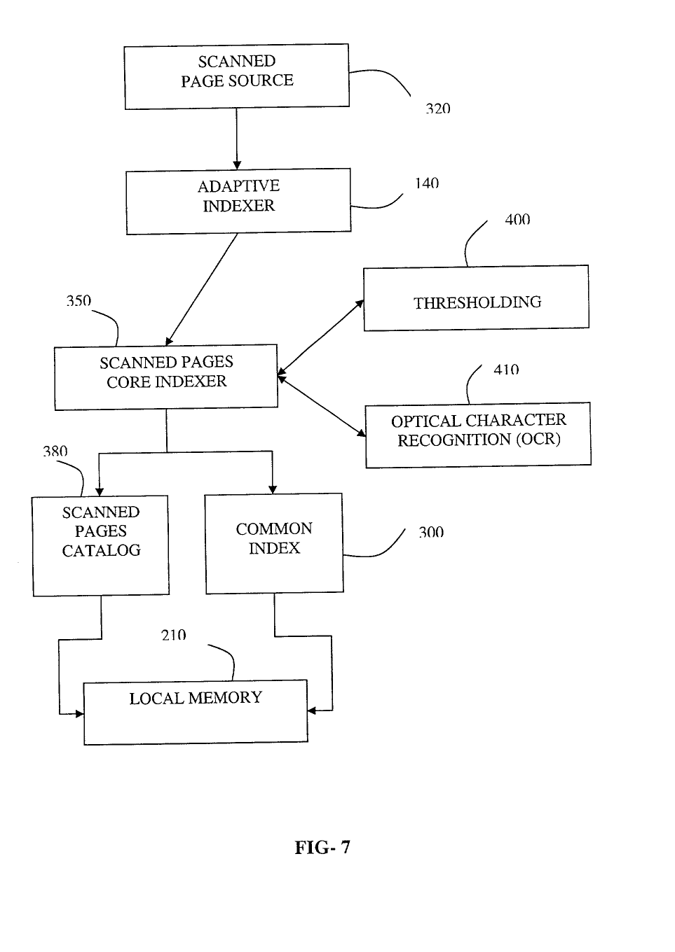

The embodiments embodying the indexing of emails, scanned pages and word processor documents have been illustrated in FIG. 5, FIG. 6, and FIG. 7 respectively.

In FIG. 5, Adaptive Indexer 140 receives email content from email Source 310. Adaptive Indexer 140 determines the content type and forwards it to the email core indexer 340, which performs core indexing and updates the email catalog 370 and common index 300. The email catalog 370 and common index 300 are then stored in the local memory 210.

In FIG. 6, Adaptive Indexer 140 receives a scanned page from scanned pages source 320. The content is forwarded to the scanned-pages core indexer 350, which performs thresholding 400 and Optical Character Recognition 410 operations on the image to extract text. Thresholding reduces the sampling depth of an image. This technique is used here to convert a color image into a bi-tonal form. The text is then indexed and catalogued in the per-user scanned pages catalog 380 and common index 300. The catalogs are then updated in the local memory 210.

In FIG. 7, Adaptive Indexer 140 receives word processor document from Word Processor Document Source 330 and forwards it to word processor document core indexer 360. The core indexer extracts text from the document indexes it and updates the per-user document catalog 390 and common index 300. The catalogs are then updated in the local memory.

The adaptive indexer 140 interfaces with index re-shuffler 180, referring to FIG. 3. Since documents may enter or leave the remote storage locations at any time, the behavior of the index should be highly dynamic in order to reflect the changes in remote server storage 150. The index re-shuffler 180 achieves this. It periodically cross-checks the index with the documents on the remote server storage 150 and updates the index accordingly. For instance, if an email message is deleted by the user, the index re-shuffler 180 removes the words contained exclusively in that email message from the email catalog of the user index. This maintains the index at an optimal level.

Further the adaptive indexer 140 interfaces with the content cataloguer 190. The entire index for a user cannot be loaded upon a search request, due to resource requirements. In a large deployment setup with a huge user-base, this factor would affect performance significantly. Cataloguing of indices is done to solve this problem. The content cataloguer 190 interfaces with the adaptive indexer 140 and maintains per-user catalogs for each of the configured content types. In accordance with the present invention, catalogs for email, scanned pages and word processor documents are maintained. For instance, the index generated for word processor documents for user A is stored in word processor documents catalog for user A, the index generated for emails for user B is stored in email catalog for user B, etc. This process enables selective loading of indices when a search request arrives. For instance, if the user wants to retrieve a scanned document, only the scanned pages catalog for the user will be loaded, instead of loading the entire index for the user. It may be noted that there are a large number of words that are commonly used by various users in different contexts. This led to the conclusion that having a common word index across all the users would conserve resources. These words are maintained in the common index and updated by the cataloguing component periodically, after scanning through user indices.

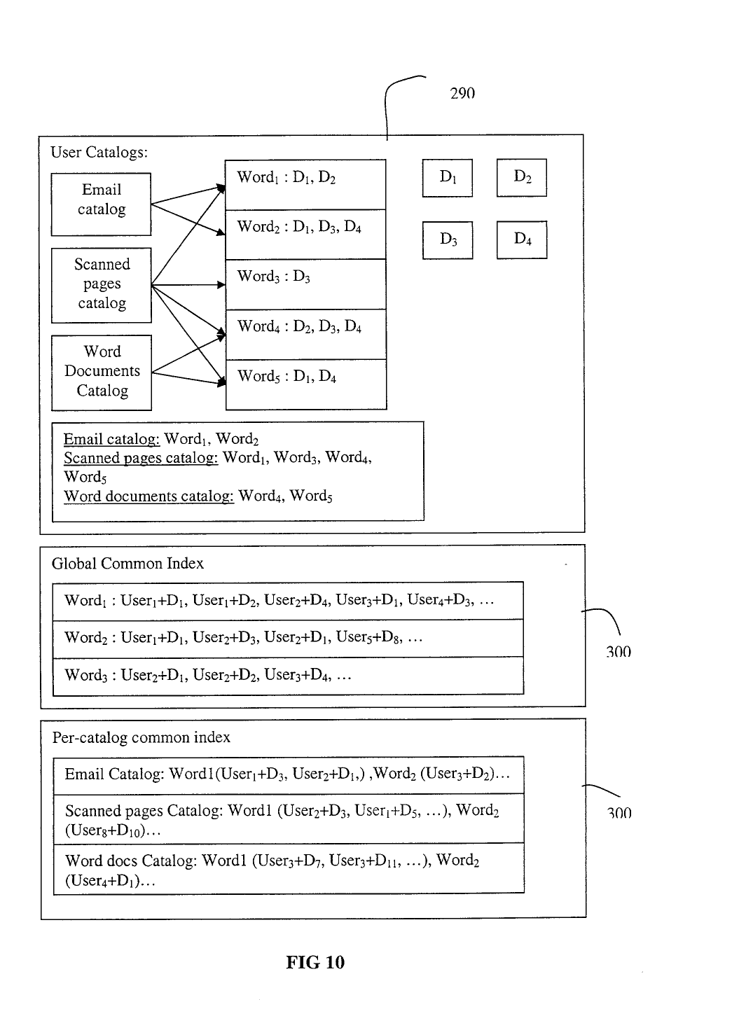

FIG. 10 illustrates user catalogs for content sources 290, per-catalog common indices and the global common index 300. The generated index is composed of index elements, each index element further comprising of a LINK-SET described in detail herein. A LINK-SET stores the access information for a document. The cataloguing component uses the following algorithm to update a per-user catalog:

1. For each index element:

a. If the element is not present in the catalog:

i. Create a new entry in the catalog for the index element

ii. Copy the index element into the catalog along with all the LINK-SET elements

b. Else

i. Locate the index element in the catalog

ii. Append all the new LINK-SET elements to the index element with the new document access information

Further the adaptive indexer 140 interfaces with the storage adapter 200. The storage adapter 200 is used to abstract the storage protocol from the system. Storage could be the native file system on the disk, a relational database, etc. In this embodiment, the storage adapter uses the native file system of the Operating System to store data. As a result it uses the file input-output operations supported by the operating systems to manipulate data.

Inverted indexing is used as the core indexing algorithm. U.S. Pat. No. 6,216,123 to Robertson, et al. describes a method for generating and searching a full-text index. The invention presented here makes use of this method for full-text indexing and search operations.

Referring to FIG. 10, the Indexer maintains two broad-level indices—the user index 290 and the common index 300. The common index 300 contains words that are common for most of the message sources as well as most users (e.g. common word for like ‘APPLICATION FORM’, ‘MEMO’, ‘PHONE’, etc.). The cataloguing component of the Indexer intelligently scans user indices to look for common words and updates the common index.

The common index 300 is further categorized into two levels—per-catalog common index and global common index. Per-catalog common index is maintained for each catalog and contains elements common to most of the users in the particular catalog. In this embodiment, the email catalog, scanned pages catalog and word processor document catalog each have a common index. This technique reduces the size of the grammar presented to the speech recognition platform. For instance, if the user requests for email search, only the global common index and the email common index will be presented to him for recognition. If the user enters another context, the email common index will be unloaded for the user and the per-catalog index for the particular context will be loaded.

Global common index is a system-wide common index and contains elements common to all the Per-catalog common indices. If an index element belongs to all the Per-catalog common indices, this element is removed from these indices and updated in the Global common index. While updating, all the document references for the element are updated as required.

The criterion for updating an element in the Per-Catalog Common Index is:

For each catalog:

For each element in the catalog:

If (element present in >=N % of user catalogs)

Update element in Per-Catalog Common Index

Where, N is determined by the type of content being search-enabled. For instance, if the content type is scanned pages in a specific format (e.g. an insurance application form), the number of common elements (words in this case) is expected to be more. As a result, N may be set to a relatively high value of 80%. However, if the content comprises of data from diverse sources, the number of common elements is expected to be less. In this case, N may be set to a relatively low value of 60%-70%. This system parameter is configurable.

The criterion for updating the Global Common Index is:

For each element in one Per-Catalog Common Index

If (element is present in all other Per-Catalog Common Indices)

Update element in Global Common Index

The user index is a per-user index maintained in the local memory. This index is categorized and maintained as catalogs. In this embodiment, three content sources are configured: email, scanned pages and word processor documents. The Indexer creates three catalogs for these sources. The respective indices are updated in the corresponding catalogs. Indices are stored in compressed format in the local memory. The system decompresses the indices while loading. Huffman coding (The Data Compression Book, Mark Nelson, M&T Books) is used for compression/decompression of indices.

Each index element in the index comprises:

ELEMENT-ID

DATA-ELEMENT

DATA-TYPE

DATA-SIZE

SOURCE-TYPE

LINK-SET

Where, DATA-ELEMENT is the actual data of the index,

DATA-TYPE is the type of data. In the current embodiment, the value of DATA-TYPE is WORD. In another embodiment this value could be an image map, color information, etc, according to the source that was indexed.

DATA-SIZE is the size of DATA-ELEMENT in bytes.

SOURCE-TYPE is the type of source document. In this embodiment, this could be EMAIL, SCANNED PAGE or WORD DOC.

LINK-SET is the element which holds the access information for the document the index element has reference to.

Each index element in the inverted index holds a reference to the source document. The source document is stored on the remote storage location. Since the system allows any type of document to be indexed, it also provides access information for the document. In the current embodiment, the content types configured are: email, scanned pages and word processor documents. Assuming the corresponding sources as EMAIL SERVER, DOCUMENT MANAGEMENT SYSTEM and HARD DISK, the index stores the required information for each of these sources in the LINK-SET element.

The format of a LINK-SET is as follows:

ACCESS-INFORMATION

RESOURCE-LOCATOR

Where ACCESS-INFORMATION is the access information, if any, required for the document. For an email,

ACCESS-INFORMATION=hostname:protocol:userid

Where, hostname is the mail server name

protocol is the access protocol used: IMAP, POP3, etc

userid is the subscriber ID of the user

RESOURCE-LOCATOR is the path of the document.

For an email,

RESOURCE-LOCATOR=serial number of email

For a scanned page in a document management system,

RESOURCE-LOCATOR=fully qualified document name

For a personal word processor document,

RESOURCE-LOCATOR=complete path on the hard disk

In another embodiment wherein one of the content sources is a web-site,

RESOURCE-LOCATOR=Complete URL of HTML page

Given a LINK-SET, the system knows how and from where to access a particular document. Actual authentication mechanism for accessing a document is provided by source program from which the document originated.

Further the system includes an exclusion dictionary 430. In case of text index, in order to prevent the size of the index from growing exponentially, the adaptive indexer extracts only common nouns and proper nouns for indexing. All verbs, pronouns, adjectives, etc are excluded from indexing. This is because the system is targeted for keyword search and the user is most likely to utter a noun during a voice-based search request. Also, indexing of verbs, adverbs, etc would increase the size of the index significantly. A part-of-speech disambiguation mechanism is use to extract the required words. U.S. Pat. No. 6,182,028, by Karaali, et al. describes a part-of-speech disambiguation method using hybrid neural network, stochastic processing and lexicon. The invention presented here makes use of this method for word exclusion.

The dynamic grammar generator 230 in FIG. 3 generates speech recognition grammar for search requests. It uses the user index 290 and common index 300 shown in FIG. 10 and performs context-sensitive selective loading of indices.

The common grammar is generated from the common index 300 shown in FIG. 4. Since common index 300 is common for most of the users, this index is loaded only once into the system, and updated periodically. This saves loading and unloading time. The common grammar is generated in W3C format. The common grammar also contains defaults like dates, numbers, digits, day of the week, etc, which is common for all the users. The user grammar is created from the user index and is loaded only during the actual search request. Depending on the context, the dynamic grammar generator first loads the user index from a particular catalog, scans through the entire set of index elements, removes duplicate elements, if any and creates a grammar in W3C format. Following is a simple user grammar for a user requesting email search:

<?xml version=″1.0″?>
<grammar xml:lang=″en-US″ version=″1.0″ root=″ROOT″>

<rule id=″ROOT″ scope=″public″>

<one-of>

<item>HOROSCOPE</item>
<item>DRAGON</item>
<item>FRANK DENNIS</item>
<item>PEDOMETER</item>
<item>LUNETTE</item>
<item>WRIST-REMOTE-CONTROLLER</item>
.....

<one-of>

</rule>

</grammar>

According to the grammar shown above, user can speak any of the words present in the grammar and the speech recognition platform would recognize these words for this particular search request, for this user. If the same user enters a different context, e.g. scanned pages search, this grammar would be unloaded first and a new grammar would be created:

<?xml version=″1.0″?>
<grammar xml:lang=″en-US″ version=″1.0″ root=″ROOT″>

<rule id=″ROOT″ scope=″public″>

<one-of>

<item>FAX</item>
<item>SPRINGWARE</item>
<item>HATCHBACK</item>
<item>DRAWING </item>
.....

<one-of>

</rule>

</grammar>

In FIG. 3, Markup generator/parser 240 is used to create and parse markup language voice based documents. The Markup generator/parser 240 uses a third-party core XML (Extended Markup Language) parser, e.g. Xerces XML Parser provided by Apache (http://xml.apache.org), to parse VoiceXML documents.

Speech recognition grammar is presented to the speech recognition platform 130 as a VoiceXML document by the VIR Interface 220. The use of VoiceXML ensures interoperability with a variety of speech recognition systems. The system supports file-mode grammar with the VoiceXML standard. A temporary grammar file is created in the local memory and its reference is put in the VoiceXML. The speech recognition platform 130 can access this file and load the grammar. For this, the speech recognition platform 130 must support W3C grammar.

Following is a sample VoiceXML document for the speech recognition grammar:

<?xml version=′1.0′?>
<vxml version=″1.0″>

<var name=″var1″/>
<var name=″var2″/>
<form id=″MAIN″>

<field name=″search_input1″>

<grammar src=″user1.grm″/>
<prompt cond=″TEXT″>

Please say your first search key word. Or say Done if you are finished.

</prompt>
<filled>

<assign name=″var1″ expr=″search_input1″/>
<if cond=″search_input1 == ′Done″′>

<goto next=″#submit_search″/>

</if>

</filled>

</field>
<field name=″search_input2″>

<grammar src=″user1.grm″/>
<prompt cond=″TEXT″>

Please say your second search key word. Or say Done if you are finished.

</prompt>
<filled>

<assign name=″var2″ expr=″search_input2″/>
<if cond=″search_input2 == ′Done′″>

<goto next=″#submit_search″/>

</if>

</filled>

</field>

</form>
<form id=″submit_search″>

<field name=″confirm″>

<prompt cond=″TEXT″>The key words you said are

<value expr=″var1″/> and <value expr=″var2″/>Say Yes to fetch result and Say
No to re-enter.

</prompt>
<filled>

<if cond=″confirm == ′No′″>

<goto next=″#MAIN″/>

</if>
<submit next=″search_svc.jsp″ namelist=″var1 var2″/>

</filled>

</field>

</form>

</vxml>

Grammar caching is adopted whereby every time a grammar is generated, the system creates a grammar file in a section of the local memory. This file is stored for a specific amount of time. The time for which it is stored depends on the frequency of the user entering the context for which the file was generated. For instance, if the user enters email search frequently, the system will store the grammar file for that user, for his email catalog. When the user enter email search the next time, only the incremental index would be added to the grammar file. The system “learns” about the access pattern for each user over a period of time and sets the grammar caching levels.

In FIG. 3, The Voice Information Retrieval (VIR) Interface 220 is exposed by the system in order to interface with speech recognition platform 130. The VIR Interface 220 allows the speech recognition platform 130 to connect and transact with the system. When a user requests for search, the speech recognition platform 130 establishes a session with the present system through the VIR Interface 220 during which user information is passed to the system. After a connection is established, the speech recognition platform 130 can issue search requests to the system, receive search results and open the documents, based on user input. The VIR Interface 220 runs an Hyper-Text Transfer Protocol [HTTP] Server 270 to accept requests from the speech recognition platform 130. The VoiceXML sent by the system specifies the program to be called by the HTTP Server 270 to execute the request. Session information is mapped from this program to the VIR Interface 220. Following are the key operations the speech recognition platform 130 performs using the VIR Interface 220:

Connect to the system

Pass user information

Set search context

Issue search request

Receive search hits

Obtain access information to open the required document

Disconnect from the system

Search engine 250 is used for actual searching of data. It uses n-gram search for fast retrieval of data. The search engine 250 uses the per-user index and the catalogue created by the Indexer and retrieves data. Since the index is updated as and when new content comes in, it is immediately available for search. This enables the user to quickly access documents.

In FIG. 3, the adaptive indexer can be extended to support indexing of non-textual documents. For instance, it could be used to retrieve image based on image block information or tag notes. For instance, a user might want to retrieve an image, which has a red-colored block in the upper left corner and a picture in the center. The adaptive indexer 140 would maintain a list of image blocks along with color information and position and the search engine would use this information to retrieve the correct images. If images have tag notes attached, user could search for tag notes and retrieve images. Indexing is performed in two stages: primary indexing and secondary indexing. Primary indexing involves the process of core indexing of the content after applying document template. The output of this process is an inverted index with links to original documents. Secondary indexing involves optimizations like duplicate word removal, segregating of words into common index and user index, etc.

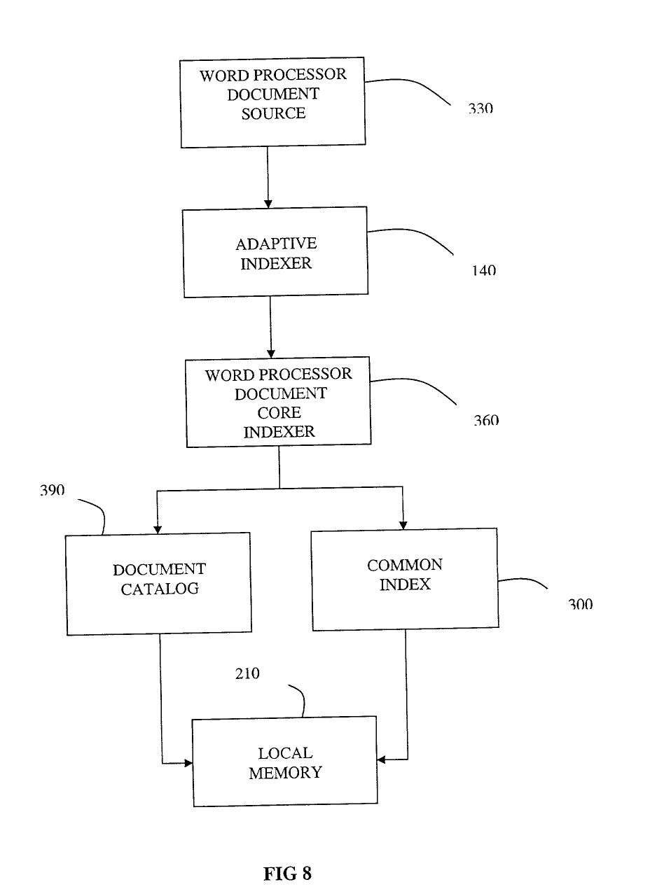

FIG. 4 illustrates the content source 280 as supplying content to core indexer. FIG. 6 illustrates the content source 310 as email content source supplying a an email to the email core indexer 340. FIG. 7 illustrates the content source as scanned page 320 being supplied to the scanned page core indexer 350. Whereas FIG. 8 illustrates the content source as word processor content source 330 supplying word processor documents to word processor core indexer 360. Since content can be in any format, the exact format of the document needs to be specified. A document template is used for this purpose. A document template represents the skeleton of a document from the indexing point of view. All incoming documents are mapped to their respective document templates by the core indexers before performing indexing. Each core indexer 170 knows the internal representation of its data source through the document template. It uses this information to extract the data required for primary indexing. The template specifies parameters like document type, areas of indexing (also referred to as AOls in this document), etc. For instance, a template for email documents may look like:

Document Type: EMAIL

| Area of indexing | Field |
|---|---|
| AOl₁ | “From” |
| AOl₂ | “Subject” |
| AOl₃ | “Date” |
| AOl₄ | “Content” |

Where, fields shown are different attributes of an email message. If indexing of the complete email message is required, AOls need not be specified. For instance, the scanned pages core indexer 350 in FIG. 7 applies the document template to a scanned page. After extracting the AOls from the page, it submits these AOls as bi-tonal images to an Optical Character Recognition (OCR) 410 to extract text. Primary indexing is then performed on the extracted text.

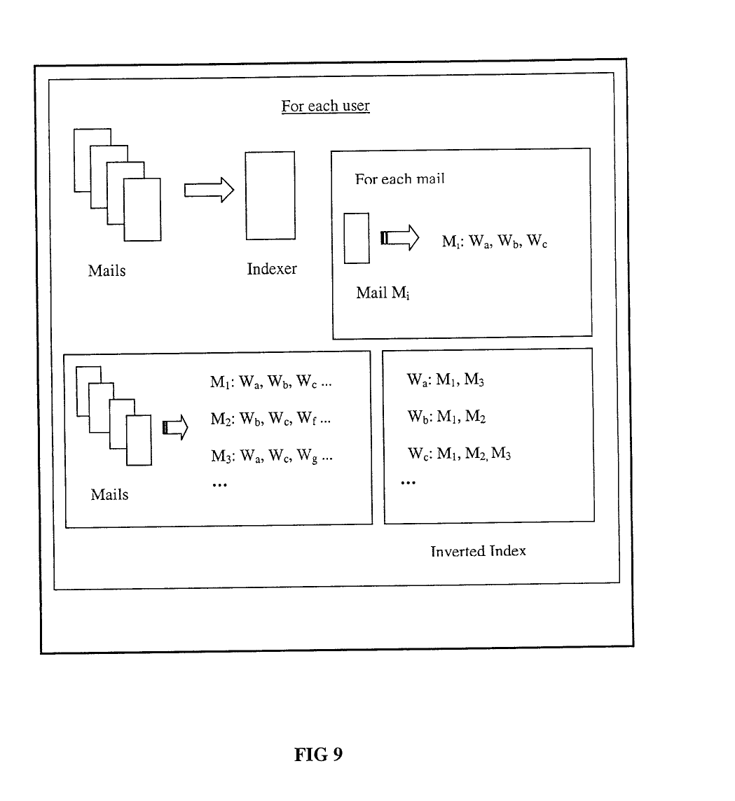

FIG. 9 illustrates a conventional inverted indexing mechanism adapted to email indexing. After applying document template for email and extracting required data, word list is first created for each incoming document for each user. After all documents are processed, all the word lists are processed to yield an output as shown. For each word, there's a link-set to the document that contains that word, which is the inverted index.

FIG. 10 illustrates a sample index generated for the source contents described in this invention. In accordance with the described content sources, each index element is a spoken “word” since text indexing is performed for all the sources. Per-catalog common index contains elements (words) common to most of the users per catalog. Global common index contains words common to all per-catalog common indices. The personal index is catalogued into categories referred to as user catalogs. Each word may belong to one or more categories. This technique enables selective loading of indices depending on the context. The per-catalog common index and the global common index have been illustrated.

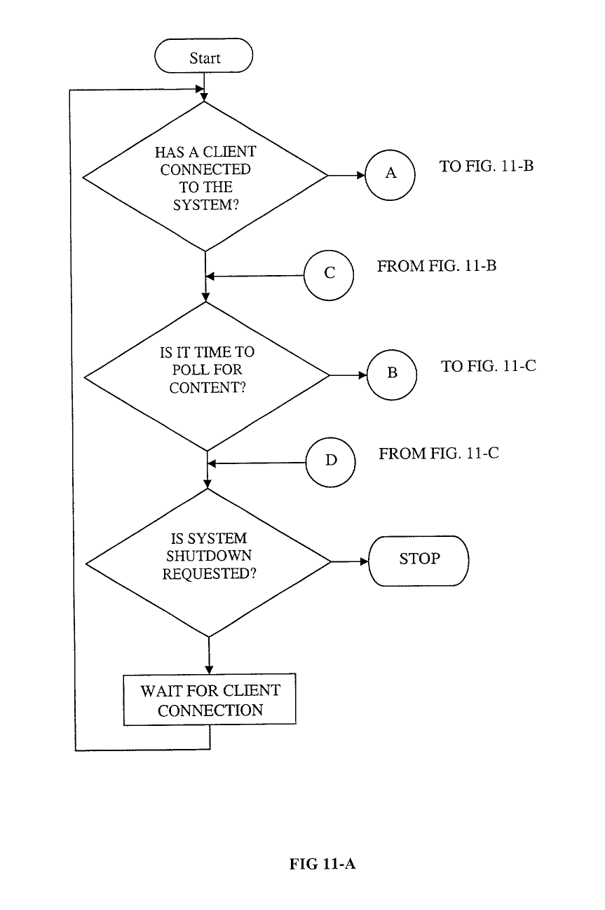

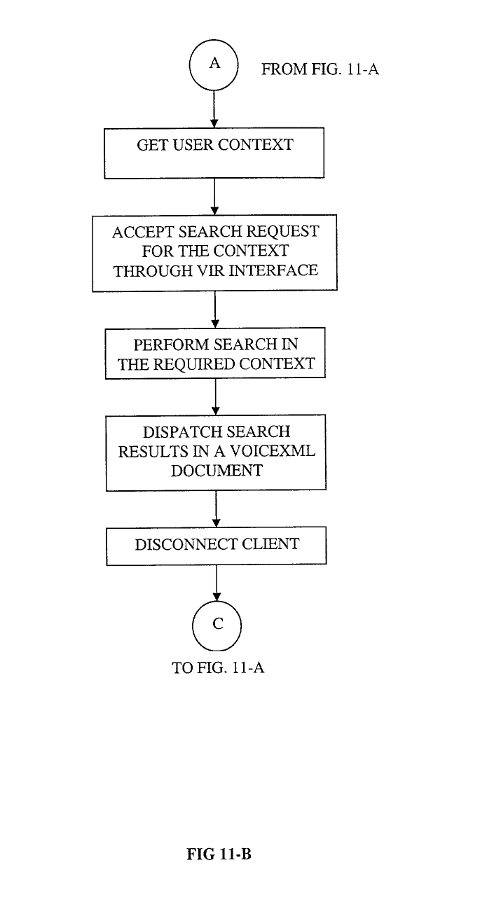

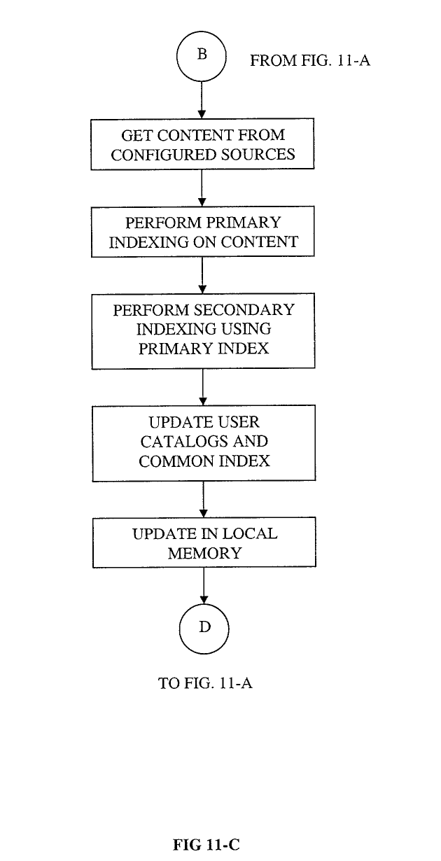

FIGS. 11-A, 11-B and 11-C depict a flow chart illustrating the method of operation of the systems shown in FIG. 2 and FIG. 3.

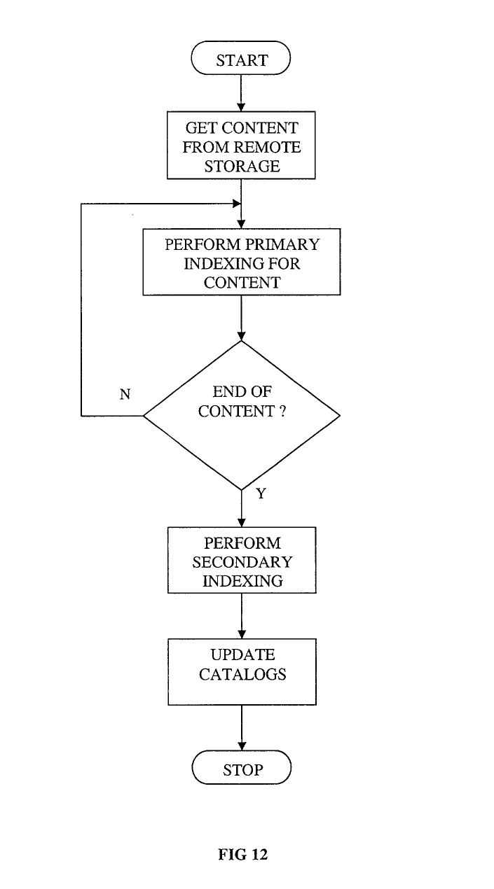

FIG. 12 is a flowchart depicting the general indexing process for all content sources. The adaptive indexer 140 polls the various message sources for content 280. When content is available primary indexing is performed on the data. The primary index in then fed to the secondary indexing process, which performs duplicate word removal and cataloguing. The catalogs are then updated in the local memory.

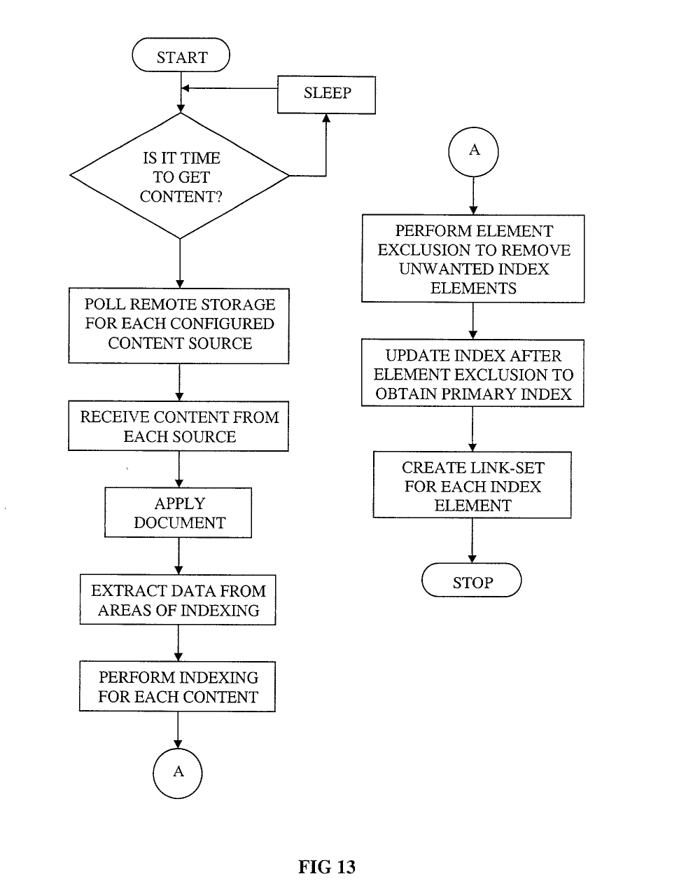

FIG. 13 depicts general primary indexing for all content sources. After polling for the content, the content is received, document template is applied and the data is extracted from Areas of Indexing. Indexing is performed on the extracted data and element exclusion is employed to remove unwanted index elements. A Primary Index is created and the LINK-SET elements are added appropriately. The index is then stored in the local memory.

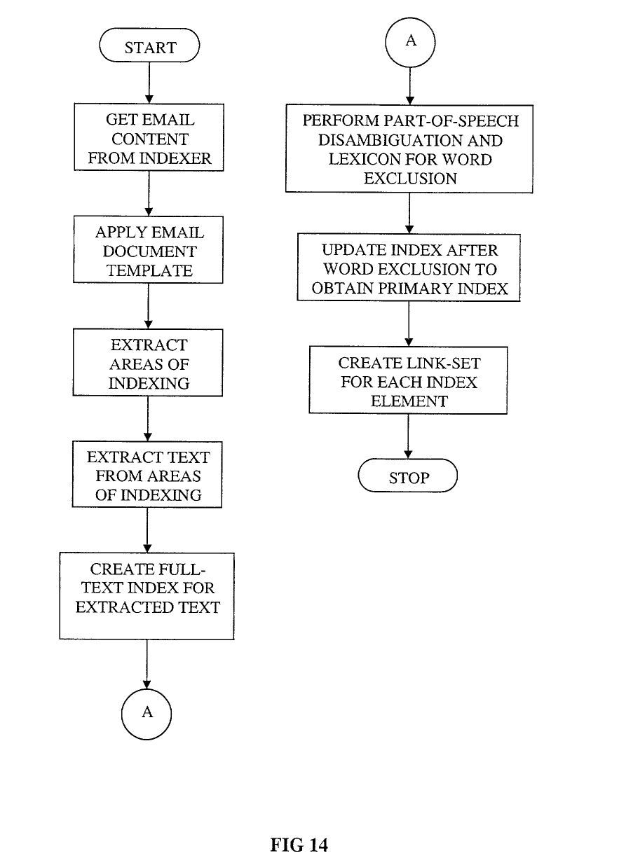

FIG. 14 is a flowchart depicting the indexing process for email content sources. After fetching email data, email document template is applied to extract Areas of Indexing. Text is extracted from Areas of Indexing and indexing is performed. The full-text index generated is then subjected to a lexicon and part-of-speech disambiguation for removal of unwanted words. Primary index is generated and LINK-SETs are added. The index is then stored in the local memory.

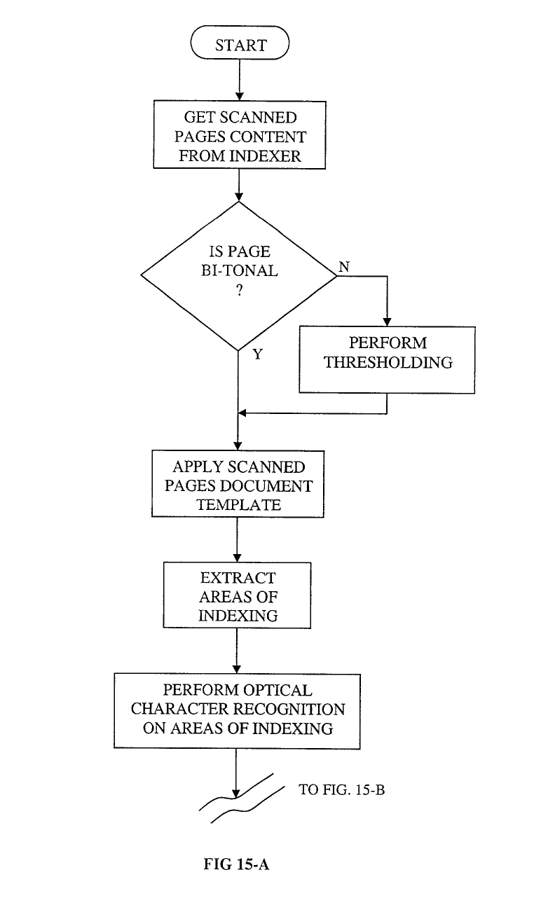

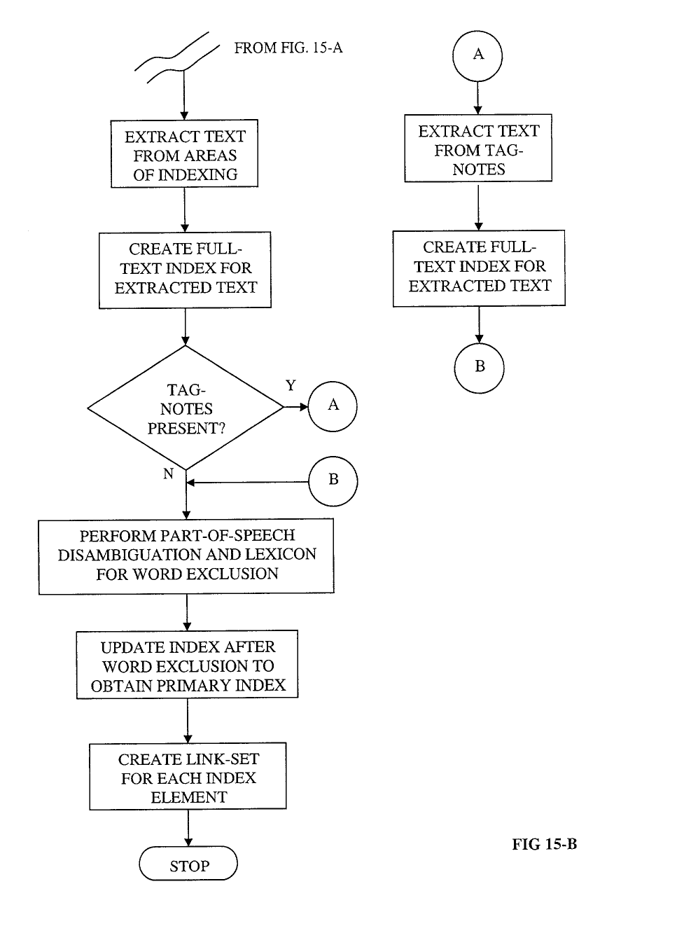

FIGS. 15-A and 15-B illustrated primary indexing for scanned pages. The scanned page could be in any color format (e.g. 24-bit color, gray scale, bi-tonal, etc). Thresholding is first performed to reduce the image to bi-tonal. Scanned pages document template is applied to extract areas of indexing. The bi-tonal output is the fed to the Optical Character Recogniser to extract text. The text is then indexed and the full-text index is subjected to unwanted word removal. If tag-notes are present full-text indexing of tag-notes is performed. The primary index thus generated is updated with LINK-SETs and stored in local memory.

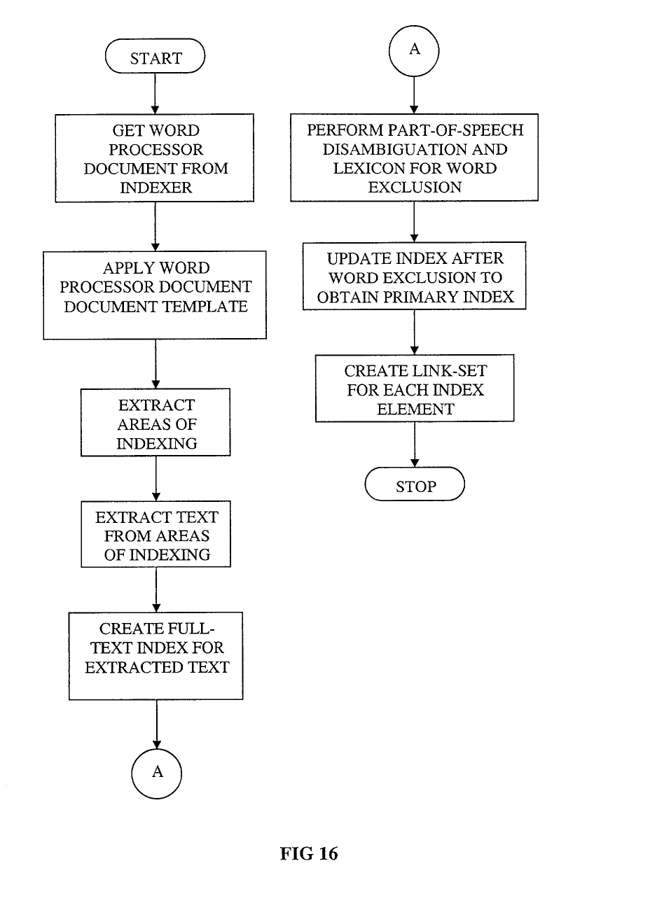

FIG. 16 is a flowchart depicting primary indexing for word processor documents.

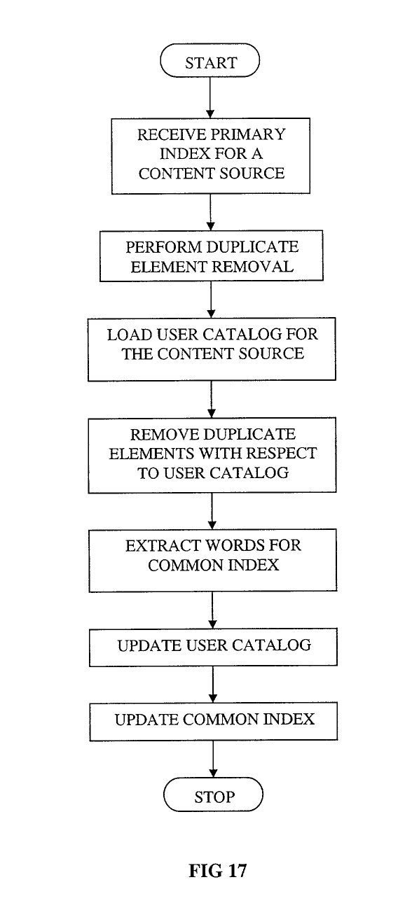

FIG. 17 is a flowchart depicting secondary indexing process. Primary index is first fetched. Duplicate element removal is then performed. User catalog for the content source is loaded and duplicate element removal is again performed with respect to the user catalog. Index elements are then extracted and the common index is updated. User catalog is updated and stored in local memory.

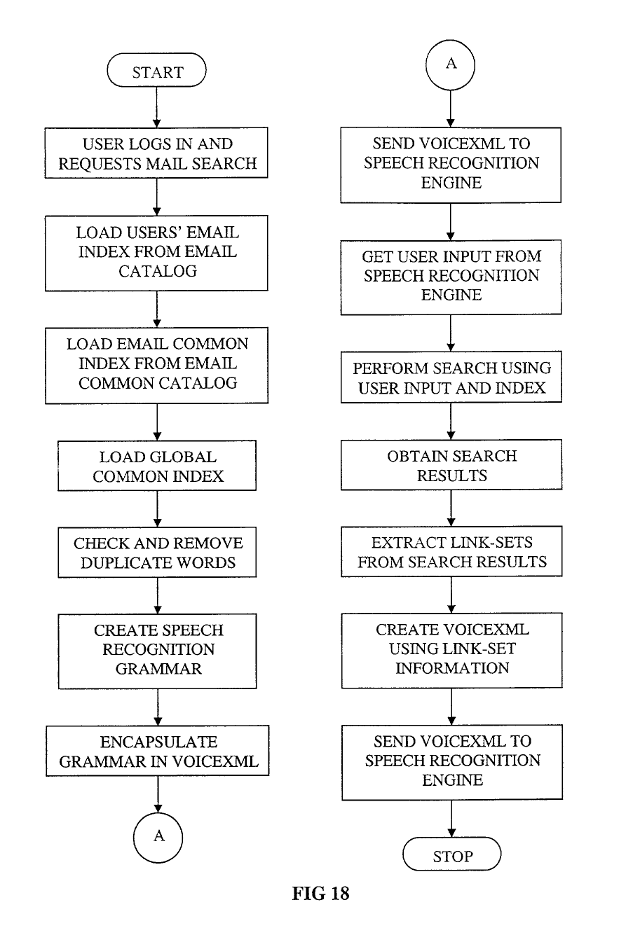

FIG. 18 shows the various steps performed for email search. When the user logs in and requests for mail search, the system loads the user's email index from the email catalog 370 as well as the common index 300. Check is again performed for duplicate words in order to keep the word list to a minimum. The word list is used to create a W3C grammar, which is then encapsulated in a markup language voice based document illustratively a VoiceXML document, which is passed to the speech recognition platform 130. The speech recognition platform 130 returns the user input, which is fed to the search engine along with the index. The search engine 250 returns the search results and the search hits are passed on to the user in markup language document illustratively a VoiceXML document.

What is claimed is:

1. A system comprising:
a remote communications device configured to communicate through a telecommunication network;
a base station in communication with the remote communications device, the base station having a data storage server for storing data, an information retrieval system having an adaptive indexer and a speech recognition platform interfacing with the adaptive indexer; the base station being configured to selectively communicate with the remote communications device, wherein the system is configured to perform voice based content search using the speech recognition platform and the information retrieval system.

2. A system according to claim 1 wherein the remote communications device comprises any device capable of communicating through a telecommunication network.

3. The system according to claim 1 wherein the remote communications device comprises a mobile phone.

4. The system according to claim 1 wherein the base station is configured to perform a search in response to a voice based search request from the remote communications device.

5. The system according to claim 1 wherein the base station is configured to provide voice based search results to the remote communications device.

6. A system for information retrieval and voice based content search, the system comprising:
a remote communications device configured to communicate through a telecommunication network;
a base station selectively in communication with the remote communications device, the base station having:
an information retrieval system comprising a server storage configured to store contents;
a content extractor configured to extract contents from the server storage;
an adaptive indexer configured to adaptively index contents extracted by the content extractor;
a core indexer configured to collect textual information from the extracted contents;
an index configurator configured to configure the adaptive indexer using the extracted contents;
a content cataloguer configured to catalogue the indexed contents;
an index re-shuffler configured to periodically reshuffle the indexed contents;
a local memory configured to store contents, the memory positioned proximally to the storage adapter;
a storage adapter configured to provide access to the contents stored in the local memory;
a dynamic grammar generator configured to generate speech recognition grammar;
a voice information retrieval interface operatively interfacing with the dynamic grammar generator;
a speech recognition platform interfacing with the voice information retrieval interface;
a markup language generator/parser configured to create and interpret contents using voice mark up languages, and wherein the base station further comprising a search engine coupled to the voice information retrieval interface, the adaptive indexer operatively connected to the content extractor, the content extractor configured to perform indexing of contents extracted from the remote server storage; the core indexer extracts textual matter from the contents, the contents being catalogued by a content cataloguer, indexed contents being stored in the local memory, the storage adapter configured to provide access to the contents stored in the local memory, the dynamic grammar generator configured to generate speech recognition grammar, the markup language generator configured to wrap the grammar into a markup language document, the voice information retrieval interface configured to send the markup language document to the speech recognition platform, the speech recognition platform configured to use the document received from the information retrieval interface to recognizing the user input, the speech recognition platform returns the results thereof to the search engine, the search engine configured to perform search using the speech recognition results and the indexed contents and returns the results thereof as a markup language document to the speech recognition platform.

7. The system according to claim 6 wherein the local memory comprises a hard drive, a floppy diskette or a compact diskette.

8. The system according to claim 6 wherein the base station is configured to perform a search in response to a voice based search request from the remote communications device.

9. The system according to claim 6 wherein the base station is configured to provide voice based search results to the remote communications device.

10. The system according to claim 6 wherein the core indexer is configured to extract textual data from emails.

11. The system according to claim 6 wherein the core indexer is configured to extract textual data from scanned documents.

12. The system according to claim 6 wherein the core indexer is configured to extract textual data from any of the word processor documents.

13. The system according to claim 6 wherein the base station is configured to define algorithms to integrate with application development standards for Voice XML.

14. The system according to claim 6 wherein the system is configured to define algorithms to integrate with application development standards for SALT.

15. An adaptive indexing system configured to adapt indexing contents for use in an information retrieval system, the system comprising:
an adaptive indexer configured to index contents;
a core indexer configured to implement textual extraction from contents forwarded by the adaptive indexer;
an index re-shuffler configured to at times reshuffle contents;
an index configurator configured to index the contents received by the adaptive indexer employing a plurality of configuration parameters;
an index cataloguer interfacing with the adaptive indexer configured to perform cataloguing of the contents and maintaining a per-user catalogue configured for a specific content type wherein the index cataloguer is configured to selectively load the indices upon receipt of a search request;
a duplicate word remover configured to remove duplicate words from the indexed contents;
a local memory configured to store contents, the memory positioned proximally to the storage adapter;
a storage adapter configured to provide access to the contents stored in the local memory;
an exclusion dictionary configured to exclude irrelevant words from the indexed contents;
a dynamic grammar generator configured to generate speech recognition grammar and wherein the adaptive indexer coupled to the index configurator, the core indexer and the storage adaptor indexes the contents to define a user index and a common index, the grammar generator configured to process search requests to conduct searches using the user indexes and the common indexes and performs context sensitive selective loading of indices.

16. The system according to claim 15 wherein the user index being per user index maintained in the local memory.

17. The system according to claim 15 wherein the common index comprises words common to source messages.

18. The system according to claim 15 wherein the common index comprises per-catalogue common index and global common index.

19. The system according to claim 15 wherein a programming interface is configured to create a document template for any of the configured contents.

20. The system according to claim 15 wherein the adaptive indexer uses CPU's idle time thus enabling optimal utilization of resources.

21. The system according claim 15 wherein the index provides links to original documents stored on the remote server storage, the links contain access information for an identified document.

22. The system according to claim 15 wherein the index re-shuffler is a periodic processor that maintains a clean index.

23. The system according to claim 15 wherein the per-user index and the common index are used to create the speech recognition grammar.

24. The system according to claim 15 wherein the speech recognition grammar is generated by the dynamic grammar generator with platform interoperability.

25. The system according to claim 15 wherein the dynamic grammar generator uses the index catalogs for selective loading of index; selective loading being dependent on the user-context.

26. The system according to claim 15 wherein the base station is configured to define algorithms to integrate with application development standards for voice based markup languages.

27. The system according to claim 15 wherein an optical character recognizer is configured to extract text matter from a scanned document content source.

28. The system according to claim 15 wherein an exclusion dictionary is configured to exclude unidentified word contents for purposes of indexing.

29. The system according to claim 15 wherein the said core indexer for scanned documents is configured to perform thresholding for reducing the sampling depth of an image.

30. A method for voice based content search and information retrieval; the method comprising:
sending a voice based search request by a device capable of communicating through a telecommunication network, receiving the voice based search input by a speech recognition platform, establishing a search session by the speech recognition platform conjointly with a voice information retrieval interface, generating a dynamic grammar in respect of the search input by a dynamic grammar generator, encapsulating the dynamic grammar into a voice markup language document by a markup language generator, sending the voice markup language document containing the dynamic grammar generator to the speech recognition platform, performing a speech recognition test by the speech recognition platform and returning the test results thereof to the voice information retrieval interface, conducting a search using the test results by a search engine at the local memory and employing the indexed content, providing the search results as a voice markup language documents to the speech recognition platform and returning the search results to the originator of the search input.
